(19) United States
(12) Patent Application Publication
(10) Pub. No.: US 2015/0322606 A1
(43) Pub. Date: Nov. 12, 2015

(54) HYDROFORMED COMPOSITE NONWOVEN

(71) Applicant: SCA HYGIENE PRODUCTS AB, Göteborg (SE)

(72) Inventors: Anders STRÅLIN, Torslanda (SE); Lars FINGAL, Göteborg (SE); Kaveh TONDKAR, Hisings Backa (SE)

(21) Appl. No.: 14/655,424

(22) PCT Filed: Dec. 27, 2012
(86) PCT No.: PCT/SE2012/051502

§ 371 Date: Jun. 25, 2015

(51) Int. Cl. D04H 5/02; D04H 1/492; B29C 47/00; D04H 3/011

(52) U.S. Cl. CPC D04H 5/02; D04H 3/011; D04H 1/492; B29C 47/0021; D10B 2331/04; B29K 2033/04

(57) ABSTRACT

A method for manufacturing a composite nonwoven web material includes extruding continuous filaments from a spinnerette, drawing the filaments by a slot attenuation unit to thin continuous filaments, forming a web of unbonded continuous filaments without thermobonds as the filaments are laid down, hydroentangling the web including continuous spunlaid filaments together with wet or foam formed short fibers including natural and/or synthetic fibers or staple fibers to integrate and mechanically bond and form a thermally unbonded composite nonwoven web material. A moist environment is created at the formation and lay down of the continuous filaments by the steps of laying down the filaments on an already wetted surface, keeping the width of the outlet of the slot attenuation unit open by more than 65 mm and adding liquid at the outlet of the slot attenuation unit.

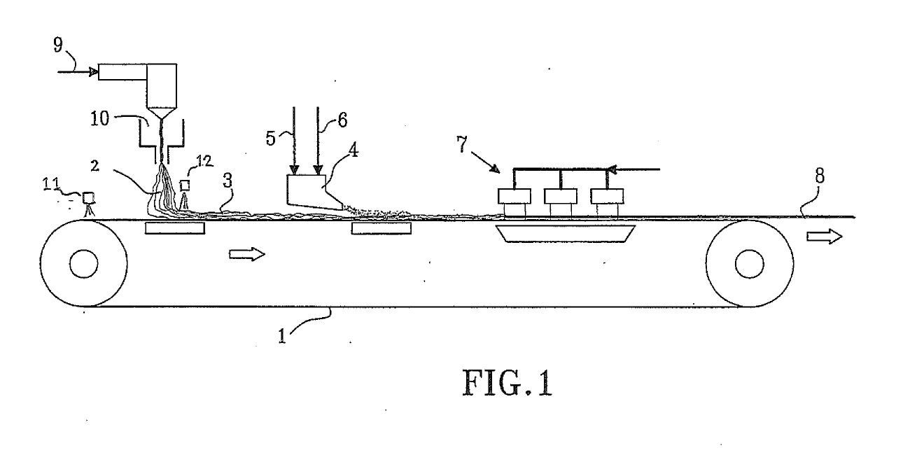

### CROSS-REFERENCE TO PRIOR APPLICATION

This application is a §371 National Stage Application of PCT International Application No. PCT/SE2012/051502 filed Dec. 27, 2012, which is incorporated herein in its entirety.

### TECHNICAL FIELD

The disclosure refers to a method for manufacturing a thermally unbonded composite nonwoven web material including continuous spunlaid filaments and wet or foam formed short fibers including natural and/or synthetic fibers or staple fibers.

### BACKGROUND

At the attenuation of polymer filaments, static charges are generated because of among other things the velocity difference between the attenuation air and filaments. Because of the great static build up of certain filaments, especially for polylactic acid (PLA) filaments, they tend to come together and when they are laid down onto the forming wire the web formation is poor, if one can get the filaments to lay down at all. The static of the filaments, also makes the transfer of the unbonded web difficult, which further results in a poor and relatively open filament web.

There have been different ways of generally dealing with static problems. U.S. Pat. No. 7,008,205 B1 shows a process that enhances the uniformity of the web by means of a device separating the filaments by an electrostatic process. U.S. Pat. No. 8,029,260 discloses an apparatus for extruding cellulose fibers, and deals, among others, with problems of preventing adjacent molten filaments touching each other. The problem is solved by an apparatus which includes an array of nozzles which are capable of extruding an aqueous solution of cellulose and a water soluble solvent along with pressurized gas so that an attenuated filament will not adhere to an adjacent molten filament.

Methods for manufacturing a hydroentangled well integrated composite nonwoven material is described in for example WO 2005/042819 and also in EP 1 694 895 B1.

Embossing technologies are used in Tissue converting to create volume between layers in multi ply tissue products. Embossing patterns are also used to strengthen and improve visual appearance. Embossing can also be used to influence the haptic feeling of the converted products.

The embossing process, where the material is embossed between a protruding patterned steel roll and a rubber roll break fiber-fiber bonds in the material. As a consequence of the destruction of the material, a weakening of the material strength is obtained.

A nonwoven wipe material made of, for instance, poly lactic acid (PLA) is relatively stiff and compact. Further, there are many problems connected to the manufacturing of the PLA filaments extruded from a PLA polymer resin wherein the filaments are attenuated and laid as a layer in an inline process, static problems along with other problems. Compared with polypropylene (PP) nonwoven based materials, PLA based materials are much stiffer because the PLA fibers/filaments have a higher modulus as compared with PP. This is also true for other fiber/filaments with a higher modulus than PP. When using these kinds of fibers or filaments in a nonwoven wipe material, usually heavy embossing is used in order to influence, for example, the haptic feeling of the converted products, but this will weaken and destroy the strength of the material.

### SUMMARY

A composite nonwoven web material is manufactured according to the following method comprising:
extruding continuous filaments from a spinnerette;
drawing the filaments by a slot attenuation unit to thin continuous filaments;
forming a web of unbonded continuous filaments without thermobonds as the filaments are laid down; and
hydroentangling the web comprising continuous spunlaid filaments together with wet or foam formed short fibers comprising natural and/or synthetic fibers or staple fibers to integrate and mechanically bond and form a thermally unbonded composite nonwoven web material.

A moist environment is created at the formation and lay down of the continuous filaments by the steps of laying down the filaments on an already wetted surface; keeping the width of the outlet of the slot attenuation unit open by more than 65 mm; and adding liquid at the outlet of the slot attenuation unit. The width of the outlet of the slot attenuation unit can also be kept open by more than 70 mm, and or more than 75 mm. The exit of the slot is also situated about 15 to 30 cm, or about 20 cm, from wetted surface or the forming wire which further creates an open gap and a moist environment.

At the attenuation of filaments, static charges are generated because of the velocity difference between the attenuation air and filaments. The velocity of the continuous filament in the slot attenuation unit is at least ten times higher than the velocity of the forming wire. The continuous spunlaid filaments are extruded from the spinnerette and drawn by the slot attenuator with a speed of more than 2000 m/min and less than 6000 m/min or less than 5000 m/min or less than 3000 m/min. The continuous filaments have a glass transition temperature Tg of less than 80° C. A capability of further molecular orientation is created in the filament as the velocity of the filaments are carefully chosen and also the importance of the speed difference between the velocity of the filaments and the speed of the forming wire is taken care of.

Because of the great static buildup of the filaments, especially with PLA filaments, the filaments tend to come together and when they are laid onto the forming wire the web formation is poor. The static of the filaments also makes the transfer of the un-bonded web difficult, which results in a poor and relatively open filaments web.

By the use of an already wetted surface is a forming wire which is wetted by adding liquid to the forming wire. It can be added to the forming wire by spraying. The surface can be sprayed with water before the lay down of the spunlaid filament. Liquid can also be added by other means in order to create an already wetted surface were the filaments can be laid upon. One could have a dipping bath or any other application of liquid or moist material to the forming wire.

Especially PLA filaments seem to generate problems as the PLA filaments are drawn by a slot attenuation unit to thin continuous filaments. They have a greater tendency to stick to each other and the spinning, landing of the PLA filaments are most difficult to handle. Surprisingly enough, the combination of a moist environment created by the added liquids and the open slot attenuation unit gives unexpected good results. Further, the speed of the filaments in relation to the speed of the web also adds to it. It was found to be impossible to form an unbonded filament web at the formation and lay down of the continuous filaments without the created moist environment as described above.

With the wetted surface and lay down of the PLA filaments in a moist environment a good PLA filament web is produced, which makes the production of spunlaced PLA and short fibers, such as PLA and pulp composites possible. Good formation can be created and a good strength of the formed web can be achieved with an even quality of the web.

In addition, to have an already wetted surface the filaments will be laid on, the moist environment is further enhanced by also spraying liquid such as water at the outlet of the slot attenuation unit and also by keeping the slot attenuation unit open at the outlet. The liquid added at the outlet of the slot attenuation unit is added by spraying as the web of unbonded continuous filaments are formed.

The moist environment will improve the formation and lay down onto the forming wire. This also improves the formation and a better formation will also improve the strength of the web.

The liquid added at the outlet of the slot attenuation unit is added such that the moisture arising from the added liquid can be evaporated to the exit of the slot attenuation unit or to the side where the forming air is introduced into the slot and such that the continuous filaments are more easily laid down forming a web of unbonded continuous filaments that makes it possible to create a composite web of short fibers and filaments, such as for example PLA filaments or other comparable filaments, with good formation.

It is difficult to get the continuous filaments to land on the forming wire. The cause of this can be due to static charges and also due to the web of filaments being so thin and airy. The conventional way to solve this problem is by having a vacuum box directly in connection to where the filaments are laid down to deal with the thin and airy continuous filaments; however this does not solve the problem. The problem becomes even more pertinent if the continuous filaments are unbonded and if they should remain unbonded until they are hydroentangled further down in the process. When certain continuous filaments, such as polylactic acid filaments, are attenuated, the problems with electrostatic charges in the process, becomes more accentuated.

The wetted surface created by wetting the forming wire before the unbonded continuous filaments are laid down, makes the filament stick to the forming wire and, in combination with adding further liquid as the continuous filaments are laid down, the light and airy filaments becomes more heavy and sticks even more easily to the already moist forming wire, and as the slot attenuation unit is kept open at the outlet this adds to creating a moist environment that will also change the charge conditions and reduce the static charges etc. The liquid added at the point where the continuous filaments are laid down will also be affected by the vacuum box and the liquid will be drawn down together with the continuous filaments and continue through the wetted forming wire. However, as the forming wire is moist already when the liquid is added at the outlet of the slot attenuation unit, this makes it easier and possible for the liquid to vaporize and create a moist environment both at the location of the lay down of the continuous filaments, but also further up the attenuation of the filament exit, i.e. before the filaments are laid down. The opening of the outlet of the slot attenuation unit enables the liquid and the vapor to create a moist environment. This moist environment reduces the electrostatic charges induced by the continuous filaments, especially by the polylactic acid continuous filaments. Compared to conventional polymers used for filaments such as for instance polypropylene and conventional polyethylene, the PLA filaments are generally more polar than those conventional filaments. It seems like the electrostatic charges that are created and other problems that arise as the PLA filaments are produced, demands thus another set up of the method and manufacture unit, and gives other challenges than what can be expected.

Further, the already wetted and now moist surface give full effects to the added liquid at the outlet of attenuation slot of the continuous filaments. The liquid can be added in a number of ways such as spraying or by a number of rows of nozzles or by using a curtain of liquids. The spraying of liquid such as water, with or without additives, enhances further the generation of vapor and a moist environment together with the moist forming wire. The spraying generates vapor also inherently, which is enhanced by the moist forming wire, and by the outlet opening that is wide enough such that the continuous spunlaid filaments extruded from a spinneret and drawn by a slot attenuator to thin unbonded filaments is done in a moist environment.

The drying of the formed composite nonwoven web material can further be embossed without any thermal bonding. The continuous filaments has a glass transition temperature Tg of less than 80° C. and a yield point of the filaments is reached during embossing and the embossing is done in the plastic region of the filaments such that they are deformed plastically. The embossing can be done such as to give first areas with first regions including stretched filaments and second areas of local reinforcement consisting of compressed regions without thermobonding with a density higher than the first areas. The compressed regions have a reduced thickness of about 5 to 60%, between 10 to 50%, or about 30%.

An embossed composite nonwoven web material is also provided with a soft and strong and durable nonwoven wipe, creating a stable embossing, which allows production of less dense wiping rolls for the consumer market. This can be achieved by a method for manufacturing a composite nonwoven web material, including:
extruding continuous filaments from a spinnerette;
drawing the filaments by a slot attenuation unit to thin continuous filaments;
forming a web of unbonded continuous filaments without thermobonds;
hydro entangling the layers including continuous spunlaid filaments together with wet or foam formed short fibers including natural and/or synthetic fibers or staple fibers to form a composite nonwoven web material; and
drying the web material.

The composite nonwoven web material is embossed without forming thermobonds giving the web material a strength index equal to or more than 1 times the strength index of the unembossed composite web material.

The composite nonwoven web material is embossed to have a strength index of more than 1.06 times, more than 1.08 times, or more than 1.1 times the strength index of the unembossed composite nonwoven web material.

It is most unexpected to get a higher strength after embossing. Usually, the strength of an embossed web is reduced compared to the same web before it is embossed. Embossing is normally considered to reduce strength in the material and can even be used to induce weaknesses into the material. Without being bound by theory, it is believed that it is the gentle method of manufacture of the filaments that is one of the reasons behind this method of creating a capability in the filaments by keeping the filaments intact and also by achieving formation of filaments in the web, and thereby making it possible to keep the strength of the material web and also be able to induce strength of the web by the embossing rather than reducing strength. The embossing heights of the protrusions of the embossing roll as well as the use of a rather soft anvil roll further makes it possible to achieve the desired three dimensional structure of the material web. However, there are also other theories behind the reasons.

Filaments are extruded from a spinnerette and drawn by a slot attenuator to thin filaments and to form a web. As the filament velocity is much higher than the line speed of the forming wire, a web of unbonded filaments is formed as the filaments hits the forming wire.

The filaments drawn by the slot attenuation unit to thin continuous filaments are not fully oriented. The continuous spunlaid filaments are extruded from the spinnerette and drawn by the slot attenuator with a speed of more than 2000 m/min and less than 6000 m/min or less than 5000 m/min or less than 3000 m/min. The continuous filaments have a glass transition temperature Tg of less than 80° C. and a yield point of the filaments is reached during embossing and the embossing is done in the plastic region of the filaments such that they are deformed plastically. A capability of further molecular orientation is thus created in the filament as the velocity of the filaments are carefully chosen and also the importance of the speed difference between the velocity of the filaments and the speed of the forming wire is taken care of. The velocity of the continuous filament in the slot attenuation unit is at least ten times higher than the velocity of the forming wire. The continuous filaments are deformed by the embossing. The molecular orientation of the continuous filaments can be enhanced during embossing by stretching and/or the filaments can also be deformed through compression but without molecular orientation.

A surprising effect was obtained as the strength of the material was increased. The observation of a strength increase together with a higher softness is very unusual.

Most likely the improved softness is obtained by the breaking of the cellulose fiber-fiber bonds. This should also result in a lower material strength. However, the opposite was observed. Most likely, the strength increase can be explained by the high compression and energy introduced to the material in the embossing points and absorbed by the continuous filaments. The continuous filaments may deform so that bonds between cellulose fibers to filaments as well as between filaments are formed. We have not been able to observe this effect when similar materials were made based on polypropylene (PP) filaments. As an example, the continuous spunlaid filaments are polylactic acid (PLA) filaments. The PLA surface chemistry as well as the glassy state and softening point at 60° C. may favour the deformation achieved by the embossing.

The composite nonwoven web material has first areas with first regions where the filaments are stretched by embossing the composite nonwoven web material and thereby increasing the molecular orientation of the continuous filaments. The first areas have enhanced strength through stretching by embossing the nonwoven composite web material.

Embossing against an anvil roll gives first areas with first regions including stretched zones and second areas with compressed zones. The first regions are adjacent to the second areas since the stretching of the filaments are usually where the material is embossed between a protruding patterned steel roll and a rubber roll which will break fiber-fiber bonds in the material but in these cases also stretch the continuous spunlaid filaments. The embossing of the composite nonwoven web material gives second areas of local reinforcement consisting of compressed regions without thermobonding with a density higher than the first areas. The continuous spunlaid filaments may be deformed by being flattened during embossing.

The embossing is performed with an embossing roll having protuberances or protrusions corresponding to the second areas of the web material with a height or depth in the range of from 1.5 mm to 3.5 mm, or about 2.5 mm. The rather high/deep embossing of the second areas of compressed regions without thermobonding have a reduced thickness of about 5 to 60%, between 10 to 50%, or about 30%.

Without being bound by theories, it is believed that there is one strength enhancement due to the stretching and molecular orientation of the filaments. It is possible that the manufacturing of the filaments allows certain molecular orientation to still take place after and also because there are no thermobonds in the composite nonwoven web which can hold back and destroy the bonding as well as tearing the filaments. The stretching is permanent since the filaments are deformed and then the filaments should then be in the plastic region and with a certain Tg as well without creating any thermobonds while embossed. The web includes thermally unbonded deformed continuous spunlaid filaments stretched by embossing. At normal embossing, the fibers are broken and if the web is spunbond the fibers are literally stuck and cannot move. The web material according to embodiments of the invention is only mechanically bonded by hydroentangling and these bondings are elastic and not firm bondings. The cellulose fiber to fiber bonds will break however the continuous filaments according to embodiments of the invention will not break but will stretch. If certain male and female embossing is used, only stretched areas are achieved, unless tip to tip or foot to foot embossing is used. The nonwoven composite web material has first areas with first regions with stretched continuous filaments and increased molecular orientation of the continuous filaments achieved by embossing. However, if the embossing is done in a firm nip, for example against an anvil roll, then also another strength enhancement is achieved by second areas of compressed zones.

The strength increase in these compressed zones are local reinforcement where the embossing gives a compression of the web which makes the fibers and filaments come closer to each other but may also give a certain compression in the filaments, thus the filaments may be flattened in the embossed second areas. The web material has second areas of local reinforcement consisting of compressed regions without thermobonding with a density higher than the first areas and a reduced thickness of about 5 to 60%, between 10 to 50%, or about 30%. A more dense material will thus increase the contact between all fibers and will give a higher local strength to the material in these compressed areas. There will be a greater area which will also increase the friction between the fibers. The compressed fibers will even further add to a better contact and bonding between the fibers, hydrogen bonding, van der waals bonding and enhanced molecular contact together with an even more integrated web and will increase the strength even though there will be no thermobonding in the embossed spots, the embossing will be remaining since the embossing is done in the plastic region of the filaments. The short fibers such as the cellulose fibers will also stick into any cavities and also further enhance the dense structure creating the local reinforcement. It is believed that the friction energy developed by the embossing pressure is absorbed in the surface of the filaments due to the stiffness of the filaments and can thus also add to the theories of how this strong bonding without thermobonds is achieved.

### BRIEF DESCRIPTION OF THE DRAWINGS

Embodiments of the invention will be more closely described with reference to the enclosed FIGURES.

FIGURE shows schematically an exemplary embodiment of a device for producing a hydroentangled composite nonwoven material.

### DETAILED DESCRIPTION OF PARTICULAR EMBODIMENTS

The composite nonwoven web material includes a mixture of continuous spunlaid filaments and short fibers including natural fibers and/or staple fibers. These different types of fibers as well as other details of embodiments of the invention are defined as follows.

### Continuous Filaments

Filaments are fibres that in proportion to their diameter are very long, in principle endless. They can be produced by melting and extruding a thermoplastic polymer through fine nozzles, thereafter the polymer will be cooled, such as by the action of an air flow blown at and along the polymer streams, and solidified into strands that can be treated by drawing, stretching or crimping. Chemicals for additional functions can be added to the surface. Filaments can also be produced by chemical reaction of a solution of fibre-forming reactants entering a reagence medium, e g by spinning of viscose fibres from a cellulose xanthate solution into sulphuric acid.

Meltblown filaments are produced by extruding molten thermoplastic polymer through fine nozzles in very fine streams and directing converging air flows towards the polymers streams so that they are drawn out into continuous filaments with a very small diameter. Production of meltblown is e g described in US patents 3,849,241 or 4,048,364. The fibres can be microfibres or macrofibres depending on their dimensions. Microfibres have a diameter of up to 20 μm, usually 2-12 μm. Macrofibres have a diameter of over 20 μm, usually 20-100 μm.

Spunbond filaments are produced in a similar way, but the air flows are cooler and the stretching of the filaments is done by air to get an appropriate diameter. The fibre diameter is usually above 10 μm, usually 10-100 μm. Production of spunbond is e g described in US patents 4,813,864 or 5,545,371.

Spunbond and meltblown filaments are as a group called spunlaid filaments, meaning that they are directly, in situ, laid down on a moving surface to form a web, that further on in the process is bonded. Controlling the ‘melt flow index’ by choice of polymers and temperature profile is a factor of controlling the extruding and thereby the filament formation. The spunbond filaments normally are stronger and more even.

Tow is another source of filaments, which normally is a precursor in the production of staple fibres, but also is sold and used as a product of its own. In the same way as with spunlaid fibres, fine polymer streams are drawn out and stretched, but instead of being laid down on a moving surface to form a web, they are kept in a bundle to finalize drawing and stretching. When staple fibres are produced, this bundle of filaments is then treated with spin finish chemicals, normally crimped and then fed into a cutting stage where a wheel with knives will cut the filaments into distinct fibre lengths that are packed into bales to be shipped and used as staple fibres. When tow is produced, the filament bundles are packed, with or without spin finish chemicals, into bales or boxes.

Any thermoplastic polymer, that has enough coherent properties to let itself be drawn out in this way in the molten state, can in principle be used for producing meltblown or spunbond fibres. Examples of useful polymers are polyolefines, such as polylactides, polypropylene, polyesters, and polyethylene. Copolymers of these polymers may of course also be used, as well as natural polymers with thermoplastic properties.

The continuous spunlaid filaments were extruded from a spinnerette and drawn by the slot attenuator with a speed of more than 2000 m/min and less than 6000 m/min or less than 5000 m/min or less than 3000 m/min giving the filaments a molecular orientation which is not complete and the filaments are further stretched by the embossing.

The continuous filaments used in embodiments of the present invention have a glass transition temperature Tg of less than 80° C. and a yield point of the filaments is reached during embossing and the embossing is done in the plastic region of the filaments such that they are deformed plastically.

The continuous filaments can be based on any poly lactic acid (PLA) polymer. PLA filaments based on a homogeneous poly lactic acid resin including a mono polymer and have essentially the same melting point throughout the PLA filaments. However, other polymers and copolymers and polymers with additives based on PLA can of course be used.

### Natural Fibres

There are many types of natural fibres that can be used, especially those that have a capacity to absorb water and tendency to help in creating a coherent sheet. Among the natural fibres possible to use, there are primarily the cellulosic fibres such as seed hair fibres, e g cotton, kapok, and milkweed; leaf fibres e g sisal, abaca, pinapple, and New Zealand hamp; or bast fibres e g flax, hemp, jute, kenaf, and pulp.

Cellulose from wood pulp fibres is especially well suited for use, and both softwood fibres and hardwood fibres are suitable, and also recycled fibres can be used.

The pulp fibre lengths will vary from around 3 mm for softwood fibres and around 1.2 mm for hardwood fibres and a mix of these lengths, and even shorter, for recycled fibres.

### Staple Fibres

The staple fibres used can be produced from the same substances and by the same processes as the filaments discussed above. Other usable staple fibres are those made from regenerated cellulose such as viscose and lyocell.

They can be treated with spin finish and crimped, but this is not necessary for the type of processes used to produce the material described in embodiments of the present invention. Spin finish and crimp is normally added to ease the handling of the fibres in a dry process, e g a card, and/or to give certain properties, e.g. hydrophilicity, to a material consisting only of these fibres, e.g. a nonwoven topsheet for a diaper.

The cutting of the fibre bundle normally is done to result in a single cut length, which can be altered by varying the distances between the knives of the cutting wheel. Depending on the planned use different fibre lengths are used, between 2-18 mm are known to be used.

For hydroentangled materials made by traditional wetlaid technology, the strength of the material and its properties like surface abrasion resistance are increased as a function of the fibre length (for the same thickness and polymer of the fibre). When continuous filaments are used together with staple fibres and pulp or pulp, the strength of the material will mostly come from the filaments.

### Process

One general example of a method for producing the composite nonwoven web material according to an embodiment of the present invention is shown in the FIGURE and includes the steps of:

providing an endless forming fabric 1, where the continuous filaments 2 can be laid down, and excess air be sucked off through the forming fabric, to form the precursor of a web 3, advancing the forming fabric with the continuous filaments to a wetlaying stage 4, where a slurry including a mixture of short fibers including natural fibers 5 and/or staple fibers 6 is wetlaid on and partly into the precursor web of continuous filaments, and excess water is drained off through the forming fabric, advancing the forming fabric with the filaments and fibre mixture to a hydroentangling stage 7, where the filaments and fibres are mixed intimately together and bonded into a nonwoven web 8 by the action of many thin jets of high-pressure water impinging on the fibres to mix and entangle them with each other, and entangling water is drained off through the forming fabric, advancing the forming fabric to a drying stage (not shown) where the nonwoven web is dried, and further advancing the nonwoven web to stages for embossing, rolling, cutting, packing, etc.

According to the embodiment shown in the FIGURE, the continuous filaments 2 made from extruded molten thermoplastic pellets are laid down directly on a forming fabric 1 where they are allowed to form an unbonded web structure 3 in which the filaments can move relatively freely from each other. This can be achieved by making the distance between the nozzles and the forming fabric 1 relatively large, so that the filaments are allowed to cool down before they land on the forming fabric, at which lower temperature their stickiness is largely reduced. Alternatively, cooling of the filaments before they are laid on the forming fabric is achieved in some other way, e g by means of using multiple air sources where air 10 is used to cool the filaments when they have been drawn out or stretched to the preferred degree.

The air used for cooling, drawing and stretching the filaments is sucked through the forming fabric, to let the filaments follow the air flow into the meshes of the forming fabric to be stayed there. A good vacuum might be needed to suck off the air.

The speed of the filaments as they are laid down on the forming fabric is much higher than the speed of the forming fabric, so the filaments will form irregular loops and bends as they are collected on the forming fabric to form a very randomized precursor web. The continuous spunlaid filaments are extruded from a spinnerette and drawn by the slot attenuator with a speed of more than 2000 m/min and less than 6000 m/min or less than 5000 m/min or less than 3000 m/min. The velocity of the filaments can be between 2000-6000 m/min. The velocity of the forming web or the transport web is about 100-300 m/min. The velocity of the continuous filament in the slot attenuation unit is at least ten times higher than the velocity of the forming wire, one example is a velocity of about 2500 m/min and a speed of the forming wire of about 200 m/min. The speed and the speed relationship are chosen such that the filaments drawn by the slot attenuation unit to thin continuous filaments are not fully oriented. In this way, there is still a possibility to stretch the filaments in the after treatments such as the embossing without the filaments being torn and disrupted.

The pulp 5 and/or staple fibres 6 are slurried in a conventional way, either mixed together or first separately slurried and then mixed, and conventional papermaking additives such as wet and/or dry strength agents, retention aids, dispersing agents, are added, to produce a well mixed slurry of short fibres in water.

This mixture is pumped out through a wet-laying headbox 4 onto the moving forming fabric 1 where it is laid down on the unbonded precursor filament web 3 with its freely moving filaments. The short fibres will stay on the forming fabric and the filaments. Some of the fibres will enter between the filaments, but the vast majority of them will stay on top of the filament web. The excess water is sucked through the web of filaments laid on the forming fabric and down through the forming fabric, by means of suction boxes arranged under the forming fabric.

### Hydroentangling

The fibrous web of continuous filaments and staple fibres and pulp is hydroentangled while it is still supported by the forming fabric and is intensely mixed and bonded into a composite nonwoven material 8. An instructive description of the hydroentangling process is given in CA patent no. 841 938.

In the hydroentangling stage 7, the different fibre types will be entangled and a composite nonwoven material 8 is obtained in which all fibre types are substantially homogeneously mixed and integrated with each other. The fine mobile spunlaid filaments are twisted around and entangled with themselves and the other fibres which gives a material with a very high strength. The energy supply needed for the hydroentangling is relatively low, i e the material is easy to entangle. The energy supply at the hydroentangling is appropriately in the interval 50-500 kWh/ton.

In particular embodiments, no bonding, by e g thermal bonding or hydroentangling, of the precursor filament web 3 should occur before the short fibres 5 and/or 6 are laid down 4. The filaments should be completely free to move in respect of each other to enable the staple and pulp fibres to mix and twirl into the filament web during entangling. Thermal bonding points between filaments in the filament web at this part of the process would act as blockings to stop the staple and pulp fibres to enmesh near these bonding points, as they would keep the filaments immobile in the vicinity of the thermal bonding points. The ‘sieve effect’ of the web would be enhanced and a more two-sided material would be the result. Herein, “no thermal bondings” means that there are substantially no points where the filaments have been excerted to heat and pressure, e g between heated rollers, to render some of the filaments pressed together such that they will be softened and/or melted together to deformation in points of contact. Some bond points could, especially for meltblown, result from residual tackiness at the moment of laying-down, but these will be without deformation in the points of contact, and would probably be so weak as to break up under the influence of the force from the hydroentangling water jets.

The strength of a hydroentangled material based on only staple and/or pulp will depend heavily on the amount of entangling points for each fibre; thus long staple fibres, and long pulp fibres, are particularly used. When filaments are used, the strength will be based mostly on the filaments, and reached fairly quickly in the entangling. Thus, most of the entangling energy will be spent on mixing filaments and fibres to reach a good integration. The unbonded open structure of the filaments will greatly enhance the ease of this mixing.

The pulp fibres 5 are irregular, flat, twisted and curly and gets pliable when wet. These properties will let them fairly easily be mixed and entangled into and also stuck in a web of filaments, and/or longer staple fibres. Thus, pulp can be used with a filament web that is prebonded, even a prebonded web that can be treated as a normal web by rolling and unrolling operations, even if it still does not have the final strength to its use as a wiping material.

The entangling stage 7 can include several transverse bars with rows of nozzles from which very fine water jets under very high pressure are directed against the fibrous web to provide an entangling of the fibres. The water jet pressure can then be adapted to have a certain pressure profile with different pressures in the different rows of nozzles.

Alternatively, the fibrous web can, before hydroentangling, be transferred to a second entangling fabric. In this case, the web can also prior to the transfer be hydroentangled by a first hydroentangling station with one or more bars with rows of nozzles.

### Drying Etc

The hydroentangled wet web 8 is then dried, which can be done on conventional web drying equipment, such as of the types used for tissue drying, such as through-air drying or Yankee drying. The material is, after drying normally, wound into mother rolls before converting. The material is then converted in known ways to suitable formats and packed. The structure of the material can be changed by further processing such as microcreping, hot calandering, etc. To the material can also be added different additives such as wet strength agents, binder chemicals, latexes, debonders, etc. The structure of the material can now be changed by the embossing described.

### Composite Nonwoven Material

A composite nonwoven can be produced with a total basis weight of 40-120 g/m².

The unbonded filaments will improve the mixing-in of the short fibres, such that even a short fibre will have enough entangled bonding points to keep it securely in the web. The short fibres will result in an improved material as they have more fibre ends per gram fibre and are easier to move in the Z-direction (perpendicular to the web plane). More fibre ends will project from the surface of the web, thus enhancing the textile feeling. The secure bonding will result in very good resistance to abrasion. However, the greatest effect of a soft feel is the embossing process.

### Yield Point/Plastic Region

The yield strength or yield point of a material is defined in engineering and materials science as the stress at which a material begins to deform plastically. Prior to the yield point the material will deform elastically and will return to its original shape when the applied stress is removed. Once the yield point is passed, some fraction of the deformation will be permanent and non-reversible. The transition from elastic behavior to plastic behavior is called yield. The yield point: when the elastic limit is reached in a stress/strain curve, plastic region.

### Moist Environment

The moist environment is created at the formation and lay down of the continuous filaments by the steps of laying down the filaments on an already wetted surface, keeping the width of the outlet of the slot attenuation unit open by more than 65 mm, or more than 70 mm, or more than 75 mm and by adding liquid at the outlet of the slot attenuation unit. The moist environment is distinguished by being more humid than the relative humidity in surrounded environment. The wetted surface is created by wetting the forming wire before the unbonded continuous filaments are laid down, this can, for example, be done by spraying liquid 11. The liquid added at the point where the continuous filaments are laid down 12 will also be affected by the vacuum box and the liquid will be drawn down together with the continuous filaments and continue through the wetted forming wire. However, as the forming wire is moist already when the liquid is added at the outlet of the slot attenuation unit 12, this makes it easier and possible for the liquid to vaporize and create a moist environment both at the location of the lay down of the continuous filaments but also further up the attenuation of the filaments, i.e. before the filaments are laid down. The opening of the outlet of the slot attenuation unit enables the added liquid and the vapor to create a moist environment. The liquid added can be water and any added substances.

### Embossing

A well-known technique to increase the thickness of a paper product is to emboss the paper web. Any embossing can lead to embossed elements all having the same height or to embossing elements having different heights. An embossing process may be carried out in the nip between an embossing roll and an anvil roll.

The embossing roll is formed of a hard material, usually metal, especially steel, but there are also known embossing rolls made of hard rubber or hard plastics materials. The embossing roll can have protrusions on its circumferential surface leading to so-called embossed depressions in the web or it can have depressions in its circumferential surface leading to so-called embossed protrusions in the web.

Anvil rolls may be softer than the corresponding embossing roll and may be made of rubber, such as natural rubber, or plastic materials, paper or steel. However, structured anvil rolls, especially rolls made of paper, rubber or plastics materials or steel are also known. The hardness of the rubber chosen depends on the pressure applied and is between 50 and 95 Shore A. In particular embodiments, the value is about 45 to 60 Shore A. In certain embodiments, the embossing work can be much better with lower values on hardness in order to get a three dimensional in the structure and a deep embossing, typically 55 Shore A has been used. The combination of a high embossing structure together with a lower value of the hardness makes it possible to achieve the impressed stable embossing. It is also good that the material web can be pushed and pressed down into the rubber such that the web is deformed.

All above described methods have the following common features: the first embossing roll is formed of a hard material, usually metal, especially steel, but there are also known embossing rolls made of hard rubber or hard plastics materials. The embossing rolls can be a male roll having individual protrusions. Alternatively, the embossing roll can be a female roll with individual embossing depressions. Typical depths of embossing patterns are between 0.8 mm and 1.4 mm. The embossing performed here is due to the desired stiffness of the filaments rather rough and heavy and therefore the embossing is performed with an embossing roll having protuberances or protrusions corresponding to the second areas of the web material with a height or depth in the range of from 1.5 mm to 3.5 mm, or about 2.5 mm. This together with the stable deformation of the filaments induced into the web material also results in rather high bulk of the web material.

Another well-known embossing technique includes a steel embossing roll and a corresponding anvil steel roll (so-called Union embossing). The surfaces of these rolls are being formed in such a manner that deformation of the web is achieved within one single embossing step.

The embossing not only serves to provide bulk to the fibrous nonwoven product but in this case also to provide an improved strength to the product. The strength of a product is important for consumer products. The conventional reason for embossing is in addition to create bulk, to generate higher absorbency or improved perceived softness.

The embossing is performed without applying any heat. There might be some heat generated by the embossing since pressure is applied, and frictional forces may give raise to some heat, however no heat is added to the process as such.

An example of the embossing is that it is made with a depth of the embossing protrusions of about 2.5 mm against an anvil roll of a hardness of 55 Shore A. The repeat height is 13.3 mm and the repeat width is 5.7 mm and the embossing FIGURE is an oval of 3.8×2.2 mm and a depth of 2.5 mm. Every other row of oval embossments is aligned and the rows in between are centrally offset in the middle and in turn also aligned by every other row. The oval has its length in the machine direction of the web material. But of course, the present invention is not restricted to any specific embossing pattern, but any embossing pattern can be used. The embossed area is about 20 percent but can optionally be anything from 3 to 20 or even 50%, or between 10 and 30%. In fact, as the embossing is not destructive, the embossed area can be chosen rather freely.

The softness of the anvil roll together with the height of the embossing protrusion is a combination that has carefully been elaborated. Further, the amount of embossing spots in an area can also influence. In the above mentioned example, there are 2.9 spots per cm².

The invention is further described more closely below by detailed embodiments. The invention may however be embodied in many different forms and should not be construed as limited to the embodiments set forth in the description thereto.

### EXAMPLES

The test material web was produced as described above and had the following composition. Short fibers including 70 wt % of cellulose pulp fibers supersoft sulphate pulp supplied from International Paper, 5 wt % 12 mm short cut PLA staple fiber 1.7 Dtex (corresponding 13.2 μm) from Trevira. 25 wt % spunlaid PLA filaments with an average diameter of 16.5 μm or 2.6 dtex extruded from PLA resins 6202D from Natureworks. The web was hydroentangled from one side. The continuous spunlaid filaments extruded from the spinnerette were drawn by the slot attenuator by a speed of about 2500 m/min, the web speed was about 200 m/min.

Evaluations concerning strength properties in dry and wet condition and the calculated strength index gave the result presented in Table 1 below.

Strength index is calculated by the equation:

Strength index=\sqrt{(strength MD*strength CD)}/Basis weight

TABLE 1

| | | Base Material | Embossed | Strength |
|---|---|---|---|---|
| Sample | | produced | Product | Increase |
| Parameter | Unit | Mean | Mean | [%] |
| Strength_MD | N/m | 1064 | 1437 | 35 |
| Strength_CD | N/m | 676 | 729 | 8 |
| Strength_index_MDCD | Nm/g | 14.0 | 17.0 | 19 |
| Stretch_MD | % | 32 | 37 | |
| Stretch_CD | % | 50 | 52 | |
| Stretch_MDCD | % | 40 | 43 | |
| Strength_MD_water | N/m | 835 | 912 | 9 |
| Strength_CD_water | N/m | 658 | 708 | 8 |
| Strength_index_MDCD- | Nm/g | 12.3 | 13.3 | 9 |
| water | | | | |
| Thickness | um | 418 | 518 | |
| Basis Weight | g/m2 | 60.5 | 60.3 | |

The following test methods were used:

Dry strength: SS-EN-ISO 12625-4:2005;

Wet strength: SS-EN ISO 12625-5:2005 (measured in water);

Grammage: SS-EN-ISO 12625-6:2005.

By using embossing technology on PLA based nonwoven material manufactured as described above, a soft, strong and durable PLA-cellulose composite wipe material was made. The embossing becomes more stable as compared with PP, which allows production of less dense wiping rolls for the consumer market. The same embossing using PP filaments does not result in a stable embossing after the web material is rolled on rolls, however using the PLA based material manufactured and embossed according to embodiments described above the embossing stays stable. Without the embossing, the rolls becomes too heavy and contains too many sheets, which will be difficult to sell on the consumer market.

Evaluations concerning bulk properties of the embossed composite nonwoven material web with an embossing depth of the protuberances of the embossing roll of about 2.5 mm gave the result presented in Table 2 below.

TABLE 2

| | Basis | | |
|---|---|---|---|
| | weight | Thickness | Bulk |
| Sample | [g/m2] | [um] | [cm³/g] |
| 1 | 62.1 | 509 | 8.2 |
| 2 | 59.7 | 516 | 8.6 |
| 3 | 62.9 | 557 | 8.9 |
| 4 | 62.4 | 551 | 8.8 |
| 5 | 63.1 | 552 | 8.8 |
| 6 | 66.2 | 544 | 8.2 |

For each sample thickness and basis weight for four samples at 10×10 cm was measured. The following test methods were used:

Grammage: SS-EN-ISO 12625-6:2005;

Thickness: SS-EN ISO 12625-3:2005. Deviations from standard method: a) thickness is measured after 25-30 seconds; b) the thickness is measured at five different places on the sample; c) precision dead-weight micrometer sink speed is 1.0 mm/s.

1. A method for manufacturing a composite nonwoven web material comprising:
extruding continuous filaments from a spinnerette;
drawing the filaments by a slot attenuation unit to thin continuous filaments;
forming a web of unbonded continuous filaments without thermobonds as the filaments are laid down;
hydroentangling the web comprising continuous spunlaid filaments together with wet or foam formed short fibers comprising natural and/or synthetic fibers or staple fibers to integrate and mechanically bond and form a thermally unbonded composite nonwoven web material;
wherein a moist environment is created at the formation and lay down of the continuous filaments by the steps of laying down the filaments on an already wetted surface; keeping the width of the outlet of the slot attenuation unit open by more than 65 mm; and adding liquid at the outlet of the slot attenuation unit.

2. The method according to claim 1, wherein the width of the outlet of the slot attenuation unit is kept open by more than 70 mm.

3. The method according to claim 1, wherein the continuous filaments have a glass transition temperature Tg of less than 80° C.

4. The method according to claim 1, wherein said continuous spunlaid filaments are polylactic acid filaments.

5. The method according to claim 1, wherein the continuous filaments are PLA filaments based on a homogeneous poly lactic acid resin comprising a mono polymer and having essentially the same melting point throughout the PLA filaments.

6. The method according to claim 1, wherein the velocity of the continuous filament in the slot attenuation unit is at least ten times higher than the velocity of the forming wire.

7. The method according to claim 1, wherein said continuous spunlaid filaments are extruded from a spinnerette and drawn by the slot attenuator with a speed of more than 2000 m/min and less than 6000 m/min.

8. The method according to claim 1, wherein the liquid added at the outlet of the slot attenuation unit is added by spraying as the web of unbonded continuous filaments are formed.

9. The method according to claim 1, wherein the wetted surface is a forming wire wetted by adding liquid to the forming wire.

10. The method according to claim 1, wherein the liquid is added to the forming wire by spraying.

11. The method according to claim 1, further comprising drying of the formed composite nonwoven web material, and embossing the web material without thermal bonding such that the embossing gives the thermally unbonded composite web material of filaments and short fibers a strength index equal to or more than 1 times the strength index of the unembossed composite web material.

12. The method according to claim 1, wherein the continuous filaments have a glass transition temperature Tg of less than 80° C. and that the yield point of the filaments is reached during embossing and the embossing is done in the plastic region of the filaments such that they are deformed plastically.

13. The method according to claim 1, wherein the embossing is done against an anvil roll and gives first areas with first regions comprising stretched filaments and second areas of local reinforcement consisting of compressed regions without thermobonding with a density higher than the first areas.

14. The method according to claim 1, wherein second areas of compressed regions of the nonwoven composite web without thermobonding have a reduced thickness of about 5 to 60%.

15. A nonwoven composite web of continuous spunlaid filaments and short fibers manufactured according to claim 1.

16. A method of using the nonwoven composite web of continuous spunlaid filaments and short fibers according to claim 15.

17. A method of using the nonwoven composite web of continuous spunlaid filaments and short fibers according to claim 15, comprising wetting the nonwoven composite web of continuous spunlaid filaments and short fibers.
